(19) United States
(12) Patent Application Publication
(10) Pub. No.: US 2012/0005916 A1
(43) Pub. Date: Jan. 12, 2012

(54) PROCESS FOR DRYING BREWER'S SPENT GRAINS

(76) Inventors: Benito Lopez, Ciudad Autonoma De Buenos Aires (AR); Augusto Copello, Ciudad Autonoma De Buenos Aires (AR); Rodrigo Martin Pontiggia, Ciudad Autonoma De Buenos Aires (AR); Hector Fernandez, Ciudad Autonoma De Buenos Aires (AR)

(21) Appl. No.: 13/127,819

(22) PCT Filed: Nov. 20, 2008
(86) PCT No.: PCT/US2008/084135

§ 371 Date: Jul. 25, 2011

(30) Foreign Application Priority Data
Nov. 5, 2008 (AR) P 08 01 04849

(51) Int. Cl. F26B 5/14

(52) U.S. Cl. 34/398

(57) ABSTRACT

A process for drying brewer's spent grains, so as to obtain a product with moisture lower than or equal to 15% by weight, biologically stable in time, with high nutritional value, commercially profitable, and environmentally safe, the process comprising two phases: the first one is a mechanical pressing operation for diminishing the initial moisture of brewer's spent grains from at least 75-80% by weight, up to a lower moisture value of 70% by weight; the liquid obtained is carried to an effluent treatment plant; the solid obtained undergoes a second phase; said second phase consists of thermal drying, having two sub-phases: during the first one, the product is transported through a hot air current while during the second one, it is transported by an air current at room temperature; this way, a final product with a moisture content lower of 15% or less by weight is obtained.

### TECHNICAL FIELD OF THE INVENTION

The present invention generally refers to the treatment of solid and moist industrial effluents or by-products containing utilizable materials after a drying process. Industries providing these kinds of products or effluents include breweries and those elaborating fermented and/or distilled beverages.

By utilizable material it is to be understood any industrial moist effluent or by-product which can undergo a drying process for obtaining a product with a moisture content lower than 15% by weight and which can be subsequently used as foodstuff for humans and animals or else in subsequent processes for obtaining fibers and proteins, individual building materials, or concrete or cement mixtures, fungus and bacteria culture medium, etc.

Particularly, the present invention refers to a process for drying brewer's spent grains (which is a brewing by-product) and thereby obtaining a stable economic product having higher storage life, ready for transport and which may be used for human or animal feed.

### STATE OF THE ART AND PROBLEMS TO BE SOLVED

Brewer's spent grains are obtained during the brewing process. They are formed by the barley malted “spent” grains and adjuncts added thereto after having obtained the must for brewing. Brewer's spent grains have high moisture content (80%), therefore it is necessary to carry out a conditioning step to suitably preserve, transport or manipulate them in subsequent processes.

It is the highest volume by-product of breweries: per each 10 liters of elaborated beer, about 2 Kg brewer's spent grains are obtained. However, although there is an elevated availability, and considering that brewer's spent grains are highly nutritional due to their protein and fiber content and high energetic value, at present, they are not used in a suitable way.

In view of the above, a process has been developed, which allows for obtaining a biologically stable, commercially profitable, and environmentally safe product.

In the brewing process, the main ingredients used are malt, water, yeast, and hop. Malt is made up with cereal grains, commonly barley, which are firstly germinated and than desiccated. Apart from barley, other malted or raw grains can be used as starch source, depending on the brewery.

The first phase in brewing is malting. The goal of this phase is stimulating the enzyme production, most of them α-amylase- and β-amylase-like, so that they can act on starch, degrading same in shorter carbohydrate chains, mainly maltose. Enzymatic production starts with barley grain germination. Shoot growth stimulates the enzymatic emission reducing the starch content of the grains. Subsequently, by means of a drying process, germination is interrupted. During said process, grain dehydration is performed under controlled temperature, moisture, and air flow conditions. The drying process finishes when color and moisture suitable for each type of malt are obtained.

Briefly, what is obtained from malting is a disaggregated endosperm which will intervene in brewing.

Subsequently, malt is milled, mixed with water, and temperature is raised to promote enzymatic hydrolysis of the constituents thereof. During this process, starch is transformed in single sugars, and proteins are degraded to polypeptides and amino acids. As a result of said transformation, known as malt maceration, a sugary and clear liquid is obtained, called “must”, which contains all the soluble compounds utilizable in the subsequent fermentation during brewing. In the must production, malt can be used singly or in combination with other malted or non-malted starch sources. The insoluble and non-degraded part is used for forming a “bed” allowing for filtering the must. The solid obtained is “brewer's spent grain”.

Subsequently, the must is boiled and hop is added thereto. After this, the hop is removed and the must is air-dried. Following this, the must is inoculated with yeast, which generates alcohol and carbon dioxide from the single sugars. Other metabolites resulted from yeast provide the odor and flavor. Finally, the beer is cooled for ripening and then it is cleared, carbonated, packaged and pasteurized.

Brewer's spent grains contain insoluble solids resulting from the malt and any other cereal which may have been added.

Both the malted barley milling rate and the (non)addition of adjuncts varies from one brewery to another, in such a way that brewer's spent grains obtained from different factories present an heterogeneous composition. Therefore, these differences may influence the performance of the product subjected to drying.

Brewer's spent grains represent the main by-product in the brewing industry (about 2 Kg each 10 liters of elaborated beer). Their composition varies in accordance with barley variety, harvest time, malting process and adjuncts used in elaborating the alcoholic beverage. Generally, brewer's spent grains may be considered as a lignocellulosic product, protein and fiber enriched (arabinoxylans, lignin and cellulose)ⁱ, and consequently a highly nutritional product.

By virtue of their high moisture content, about 80% by weight, brewer's spent grains such as obtained during brewing process are a biologically unstable product, prone to undergone microbial degradation.

Although different methods for stabilizing and optimizing the use of this by-product have been proposed, so far no process has been developed that: 1) is economically profitable, 2) allows for obtaining a biologically stable product and preserves the nutritional qualities of brewer's spent grains, and 3) allows for processing big quantities of produced brewer's spent grains in an on-line and efficient way.

It has been studied the preservation of the pressed product (about 65% moisture) adding (or not) additives such as molasses, potassium sorbate, lactic acid bacteria, sugar or ensiling additives^{ii y iii}.

On the other hand, drying by means of rotatory ovens does not alter the final product features as long as the process is not performed under high temperatures during prolonged periods. There are several tests wherein the negative effect caused by high temperatures on the final product is analyzed^{iv}.

There are also several methods wherein fluid bed drying has been used, which may present the inconvenience of non-uniform drying^{v}.

The mostly used process for drying brewer's spent grains is performed by means of rotatory ovens requiring a high initial investment.

Therefore, it is evident the need to find a process allowing for obtaining brewer's spent grains which are relatively dry, and biologically stable, at a cost allowing for their commercialization at similar costs to those of other cereal products destined to the same applications.

### DETAILED DESCRIPTION OF THE INVENTION

The object of the present invention is to provide a process for drying brewer's spent grains, obtained as a by-product from brewing, having a moisture content of 75 to 80% by weight or even higher, so as to obtain a product which is dry, lower than 15% moist by weight, biologically stable in time and highly nutritional.

A process has been developed for drying brewer's spent grains, which comprises two phases. During the first phase, mechanical pressing is performed, wherein a portion of the water contained is removed, and subsequently, during the second phase, a process of final drying is effected by means of a thermopneumatic system, through which a moisture value suitable for preserving the product is reached, lower than 15% by weight.

The process for drying brewer's spent grains of the present invention comprises two phases:

### First Phase

It consists of the mechanical pressing operation to diminish the initial moisture of the brewer's spent grains from about 75-80% by weight or higher, to a moisture value lower than 70% by weight.

To this end, a continuous screw press is used. It has an endless screw with a decreasing pitch thread and a variable diameter axis or not, depending on the press design. The material to be pressed is transported through a slotted casing, using continuous friction and pressure to remove the water. The casing is formed by two sections with a cylindrical central cavity, through which center the endless screw horizontally rotates. The walls of the casing are constituted by metallic bars longitudinally arranged towards the product, forming the slots through which water flows.

In the press, the brewer's spent grains are subjected to pressure which gets higher as it moves to the interior of the cylinder. At the outlet end of the product, the machine has a device for regulating the pressure exerted on the brewer's spent grains. This way, the screw press allows for obtaining brewer's spent grains having a moisture content lower than 70% by weight.

Regulating the operative variables of the press, such as feeding speed of the endless screw and outlet pressure of the product, the maximum quantity of water as possible is removed by means of mechanical action. The liquid fraction removed from the press can be pumped directly towards an effluent treatment plant, or previously transported to a chamber and screw vacuum (vacuum decanter) to be subsequently moved to the effluent treatment plant.

From this vacuum, the additional fraction of the dragged solids is recovered, which is moved to the solid stream exiting the screw press. The new liquid fraction obtained in this step is pumped to an effluent treatment plant.

The product obtained in this first pressing phase has the physical appearance of a solid mass, of pulverized particles, wet and fibrous. This solid is transported by means of an endless screw or pneumatic transporter to the next phase of the process.

### Second Phase

During this second phase, drying through a “thermopneumatic” transport system is performed.

It essentially consists of a “thermopneumatic” transport operation carried out by feeding the product coming from the first phase, to a controlled-temperature air current in which the particles are suspended and dragged thereby. The dimensions of the kits used are such that they allow for the correct air to solid product ratio in such a way that the air may transport the product and, at the same time, remove moisture therefrom.

The kit used comprises a burner, providing the necessary thermal energy to the air current entering the system. The air performs the transport and drying of the product. The air flow and the product flow are co-current.

The product undergoes this second phase with moisture from the outlet of the screw press (lower than 70%), and is suspended and transported by a hot air current.

This second phase consists in two series-connected sub-phases similar as per structural dimensions and equipment.

During the first sub-phase, the solid product coming from the screw press enters by means of a feeding conduit to the drying system, wherein it is suspended and transported through an air current generated by a fan. This action is achieved by suitably regulating mass flow rates between the air and the product. In order to dry the product, the air is heated by means of a burner located on one of the transport conduit ends. As a result of the air heated at an initial temperature ranging from 170 to 260° C., the solid material particles, in suspension, interchange heat with the air, start losing water and are partially dried during the conduit path. The latter is long enough to provide the permanence time required for the product to be dried.

At the and of the transport conduit, the air-product mixture enters a first cyclone separator. The air which has been partially cooled and moist is separated by the upper part of the cyclone, while the partially dry and hot solid product is separated by the lower part thereof. This system has an additional cyclone, connected to the first one, so as to allow for the collection of residual solids which have not been retained by the primary cyclone. This operation form optimizes the collection of solid materials and minimizes their emission to the environment. The solids collected in both cyclones enter the second sub-phase.

The partially dry and hot solid product undergoes the second sub-phase, which is formed by a pneumatic transport system, whereby an air current circulates at room temperature (about 20±15° C., in mild weather regions) provided by a fan.

In this air current, the solid product is suspended and transported again. This way, it is cooled and loses part of its residual moisture, while the air is heated by thermal interchange with the solid product absorbing the moisture coming therefrom.

This air-solid mixture enters a cyclone separator, wherein the hot and moist air is separated by the upper part of the cyclone, while the cold and relatively dry solid product is separated by the lower part thereof. This system, likewise to the first sub-phase, has an additional cyclone separator in order to assist in collecting the residual solids which have not been retained by the primary cyclone.

The solids collected in both cyclones are transported to a packaging system.

All the circuit comprised by this second phase has rotatory valves which prevent the pressure downfall in the system, which is necessary for the transport to be carried out and maintain the product isolated from outside. Moreover, the conduits and cyclones have a thermal isolation coating which minimizes heat loss.

Although the design varies according to the raw material origin and features, the flow to be processed, and the number of phases necessary for thermal drying, to be carried out, said design must be adjusted in such a way that the air speeds are comprised between 4 and 30 m/s, typically between 6 and 16 m/s (cold-measured), achieving permanence times of the product between 3 to 20 seconds for the first sub-phase, typically between 4 and 8 seconds; and between 1 to 6 seconds for the second sub-phase, typically between 2 and 4 seconds.

The final product obtained by this process has a moisture content below 15%, suitable for performing other subsequent operations such as pelletization (to increase storage and transport efficiency of the product), sieving (for subsequent separation operations of the protein and fiber fractions), milling (for use with baking flours) and densification (for manufacture of briquettes and bricks), and the like.

Due to the high volume of the generated product, the dry brewer's spent grains obtained from this process can be destined to animal feed, particularly at stalls and feed lot cattle breeders.

The product obtained by the process of the present invention, may also be used in human feed by virtue of its nutritional features.

Finally, the qualities of the product obtained should be highlighted: biologically stable, easy to be mixed, low calorie, great water absorption, mineral enriched (Ca, P. Fe, Cu, Zn y Mg), low fat absorption, high fiber content and high protein content.

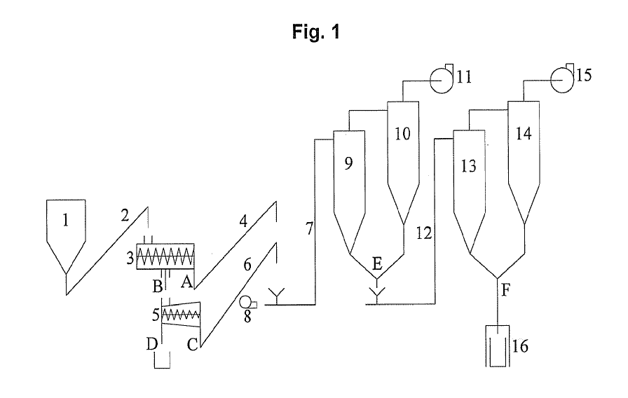

### DESCRIPTION OF FIG. 1

For better clarification and understanding of the process of the invention,

FIG. 1 depicts the schematic flow of the process.

On said diagram, the brewer's spent grains of the brewing industry are stored in tank (1), from which they are transported by an endless screw (2) to a continuous screw press (3). The solid product (A) obtained in this machine is transported by means of an endless screw (4) to the next phase of the process.

The liquid fraction (B) removed from the press is transported to a screw and chamber vacuum (5). From this vacuum it is collected the additional fraction of solids (C), which is incorporated to the solid flow (A) by means of an endless screw (6). The liquid fraction (D) obtained in this kit is pumped to an effluent treatment plant.

The solid product (A) together with the solid fraction (C) enters a hot air circulation conduit (7), wherein it is suspended and transported by means of a hot air current generated by a fan (11). In order to dry the product, the air is heated by means of a burner (8) located at one of the transport conduit ends.

At the end of the transport conduit, the air-product mixture enters a first cyclone separator (9). The air is separated by the upper part of the cyclone, while the partially dry and hot solid product (E) is separated by the lower part thereof. This system has an additional cyclone (10) series-connected to the first one, so as to allow for collecting the residual solids (E) which have not been retained by the primary cyclone (9).

The solids collected in both cyclones (E) enter a pneumatic transport system (12) whereby an air current circulates at room temperature provided by a fan (15), through which it is possible to cool and complete drying of the product.

This air-product mixture transported by the conduit (12) enters a cyclone separator, wherein the air is separated by the upper part of the cyclone, while the cold and dry solid product (F) is separated by the lower part thereof. This system, likewise to the first sub-phase, has an additional cyclone separator (14) in order to assist in collecting the residual solids (F) which have not been retained by the primary cyclone (13). The solids (F) collected in both cyclones are transported to a packaging system (16).

### EXAMPLE

A pilot-scale plant treatment on brewer's spent grains from the brewing industry was performed.

This by-product was received and stored in plastic tanks having 1000 Kg capacity. The initial moisture thereof was 79% by weight.

The product had an appearance of moist slurry. The following list provides values for the approximate composition thereof:

Scheme 1: Approximate composition of moist brewer's spent grains

| Component | %, by weight |
|---|---|
| Protein | 6 |
| Fat | 1.8 |
| Moisture | 79 |
| Ash | 0.9 |
| Fiber | 10.8 |
| Carbohydrates | 1.5 |

The process for drying brewer's spent grains comprised two phases:

During the first one, brewer's spent grains were transported from the storage tanks to the screw press used, through an endless screw transport. The mass flow rate of the product inlet to the press was about 250 Kg/h.

A continuous screw press with a processing capacity of 150-300 kg/h was used.

The treatment of brewer's spent grains in the press provided a product at the kit outlet with a moisture content of 65% by weight. This consists of a solid fraction of fibrous, shredded and moist appearance. The approximate composition is the following:

Scheme 2: Approximate composition of pressed brewer's spent grains

| Component | %, by weight |
|---|---|
| Protein | 10 |
| Fat | 3 |
| Moisture | 65 |
| Ash | 1.5 |
| Fiber | 18 |
| Carbohydrates | 2.5 |

The liquid fraction removed from the press was carried to an effluent treatment plant.

About 150 Kg/h at the screw press outlet was obtained, which was carried to the second phase of the process.

This second phase is divided in two sub-phases:

During the first one, the solid product coming from the press entered the thermopneumatic drying system by a feeding conduit. The air current generated by a fan was heated at a temperature of 250° C. through a burner located at one of the system ends. At the end of the transport conduit, the air-product mixture entered a first cyclone separator. The air was separated at the upper part of the cyclone, while the partially dry and hot solid product was separated at the lower part thereof. This system has an additional cyclone, series-connected to the first one, so as to retrieve the residual solids which have not been retained by the primary cyclone. The solids collected in both cyclones entered the second sub-phase. The kit used has a conduit with a total length of 15 meters and an inner diameter of 240 mm. The air speed in this system (cold-measured) was 11 m/s.

The solid product entered the second sub-phase, which is comprised by a pneumatic transport system whereby an air current generated by a fan circulates at room temperature. During this phase, the solid product was cooled and lost part of its residual moisture. The air-solid mixture entered a cyclone separator, wherein the air was separated at the upper part of the cyclone, while the solid product was obtained at the lower part thereof. This system, likewise to the first sub-phase, has an additional cyclone separator so as to assist in collecting the residual solids which have not been retained in the primary cyclone. The kit used has a conduit with a total length of 15 meters and an inner diameter of 240 mm. The air speed in this system (cold-measured) was 12.4 m/s.

The time output of the solids collected in both cyclones was 90 kg/h, with a moisture of 42% by weight.

This solid product entered the second phase of the process again, under the same conditions as mentioned above, with the exception of the air speed in the first sub-phase, which was 7.6 m/s (cold-measured). A product having about 10% moisture by weight and a time output of 58 kg/h was obtained. The approximate composition thereof is:

Scheme 3: Approximate composition of dry brewer's spent grains

| Component | %, by weight |
|---|---|
| Protein | 26 |
| Fat | 8 |
| Moisture | 10 |
| Ash | 4 |
| Fiber | 46 |
| Carbohydrates | 6 |

Finally, the dry product was carried by gravity to a bag mouth, and packaged into 10 Kg bags.

### BIBLIOGRAPHICAL REFERENCES

ⁱS. I. Mussatto, G. Dragone, I. C. Roberto. Brewers' spent grain: generation, characteristics and potential applications, Journal of Cereal Science 43 (2006) 1-14
ⁱⁱVictor Lilly, Martin Birch and Bryan Garscadden. The preservation of spent brewers' grains by the application of intermediate moisture food technology, J. Sci. Food Agric. (1980) 31 1059-1065.
ⁱⁱⁱD. Pelz, S. Hoffmann, Graz. Dewatering, compacting and ensiling of spent grains, Brauwelt International (1997N) 436-439.
^{iv}N. Prentice, L. T. Kissell, R. C. Lindsay and W. T. Yamazaki. High-fiber cookies containing brewers' spent grain, Cereal Chem. (1978) 55(5) 712-721.
^{v}Janusz Adamiec. Drying of waste sludges in a fluidized bed dryer with a mixer, Drying Technology, 20 839-853 (2002).

1. A process for drying brewer's spent grains, so as to obtain a product with moisture lower than or equal to 15% by weight, biologically stable in time, with high nutritional value, commercially profitable, and environmentally safe, the process comprising two phases: the first one is a mechanical pressing operation for diminishing the initial moisture of brewer's spent grains from about 75-80% by weight or more, up to a lower moisture value of 70% by weight; the liquid obtained is carried to an effluent treatment plant; the solid obtained undergoes a second phase; said second phase consists of thermal drying, having two sub-phases; during the first one, the product is transported through a hot air current while during the second one, it is transported by an air current at room temperature; this way, a final product with a moisture content lower than or equal to 15% by weight is obtained.

2. (canceled)

3. The process according to claim 1, wherein the second phase of the process is carried out twice in a consecutive way.

4. The process according to claim 1, wherein the second phase of the process is carried out twice in a consecutive way with the first sub-phase and once with the second sub-phase.

5. (canceled)

6. (canceled)
